(19) United States
(12) Patent Application Publication
(10) Pub. No.: US 2025/0252532 A1
(43) Pub. Date: Aug. 7, 2025

(54) IMAGE DISPLAY APPARATUS

(71) Applicant: LG ELECTRONICS INC., Seoul (KR)

(72) Inventors: Changsun LEEM, Seoul (KR); Junseong KIM, Seoul (KR)

(73) Assignee: LG ELECTRONICS INC., Seoul (KR)

(21) Appl. No.: 19/043,043

(22) Filed: Jan. 31, 2025

(30) Foreign Application Priority Data
Feb. 1, 2024 (KR) 10-2024-0016107
Sep. 25, 2024 (KR) 10-2024-0130116

(51) Int. Cl. G06T 3/4053; G06T 5/20; G06T 5/70; G06T 5/73; G09G 3/20

(52) U.S. Cl. CPC G06T 3/4053; G06T 5/20; G06T 5/70; G06T 5/73; G09G 3/2096; G06T 2207/20016; G09G 2340/0407; G09G 2340/0435; G09G 2340/045; G09G 2370/12

(57) ABSTRACT

An image display apparatus may include a display, an image receiver configured to receive an input image signal from an outside of the image display apparatus, and a signal processing device configured to process the input image signal and output an output image signal. In addition, the signal processing device may be configured to calculate a spatial frequency of at least part of the input image signal on a pixel basis, extract a first signal and a second signal having a higher spatial frequency than the first signal, from the input image signal based on the calculated spatial frequency, perform upscaling and super resolution processing on the first signal, and output the output image signal based on the upscaled and super resolution-processed first signal and the second signal.

### CROSS-REFERENCE TO RELATED APPLICATIONS

The present application claims priority to Korean Patent Application No. 10-2024-0016107 filed on Feb. 1, 2024 in the Republic of Korea and Korean Patent Application No. 10-2024-0130116 filed on Sep. 25, 2024 in the Republic of Korea, the entire disclosures of all these applications being expressly incorporated by reference into the present application.

### BACKGROUND

### 1. Field

The present disclosure relates to an image display apparatus, and more particularly, to an image display apparatus capable of stably improving the picture quality of an input image.

### 2. Description of the Related Art

An image display apparatus is an apparatus that displays images.

The image display apparatus is capable of displaying an image stored inside or an image received from outside.

Meanwhile, a related art document, Korean Patent Registration No. 10-20223751, relates to an upscale chipset module for UHD TV, which discloses upscaling an SD/HD/FHD source image to a UHD image so as to be optimized to UHD TV by analyzing the source image and adjusting colors and noise.

However, according to the related art document, in a case where an input image has the same resolution as the image display apparatus because of upscaling of the input image, the picture quality may be worsened due to poor upscaling.

Moreover, the related art document is disadvantageous in that high- and low-resolution regions in the input image cannot be upscaled separately.

### SUMMARY OF THE DISCLOSURE

An object of the present disclosure is to provide an image display apparatus capable of stably improving the picture quality of an input image.

Another object of the present disclosure is to provide an image display apparatus capable of stably improving picture quality while maintaining the resolving power of an input image.

Yet another object of the present disclosure is to provide an image display apparatus capable of stably improving picture quality while reducing degradation of an upscaled input image.

A further object of the present disclosure is to provide an image display apparatus capable of separately processing low resolution region and high resolution region in an input image.

An embodiment of the present disclosure provides an image display apparatus including a display; an image receiver configured to receive an input image signal from outside; and a signal processing device configured to process the input image signal and output an output image signal, wherein the signal processing device is configured to calculate a spatial frequency of at least part of the input image signal on a pixel basis, extract a first signal and a second signal having a higher spatial frequency from the input image signal based on the calculated spatial frequency, perform upscaling and super resolution processing on the first signal, and output an output image signal based on the upscaled and super resolution-processed first signal and the second signal.

The image receiver may be configured to receive the input image signal from a set-top box, and in response to the resolution of the input image signal received from the set-top box being a first resolution and the resolution of the display being the first resolution, the signal processing device may be configured to calculate a spatial frequency of the input image signal on a pixel basis, extract a first signal and a second signal having a higher spatial frequency from the input image signal than the first signal, based on the calculated spatial frequency, perform upscaling and super resolution processing on the first signal, and output an output image signal based on the upscaled and super resolution-processed first signal and the second signal.

The signal processing device may be configured to extract the first signal from the input image signal in response to the calculated spatial frequency being lower than a reference spatial frequency, and extract the second signal from the input image signal in response to the calculated spatial frequency being equal to or higher than the reference spatial frequency.

In response to the resolving power or resolution of the upscaled and super resolution-processed first signal being higher than the resolving power or resolution of the second signal, the signal processing device may be configured to output an output image signal in which the proportion of the first signal is higher than the proportion of the second signal.

In response to the resolving power or resolution of the upscaled and super resolution-processed first signal being lower than the resolving power or resolution of the second signal, the signal processing device may be configured to output an output image signal in which the proportion of the second signal is higher than the proportion of the first signal.

In response to the input image signal being an image signal input through an HDMI input terminal, the signal processing device may be configured to perform a super resolution mode for upscaling and super resolution processing.

In response to the input image signal not being the image signal input through the HDMI input terminal, the signal processing device may be configured to perform not the super resolution mode but a normal mode for signal processing.

In response to a resolution of the input image signal being the same as a resolution of the display, the signal processing device may be configured to perform a super resolution mode for upscaling and super resolution processing.

In response to the resolution of the input image signal being different from the resolution of the display, the signal processing device may be configured to perform not the super resolution mode but a normal mode for signal processing.

The signal processing device may include: a frequency divider configured to calculate the spatial frequency of the input image signal on the pixel basis and extract the first signal and the second signal having a higher spatial frequency from the input image signal based on the calculated spatial frequency; an upscaler configured to perform upscaling on the first signal; a super resolution processor configured to perform super resolution processing on the upscaled first signal; and a mixer configured to combine the upscaled and super resolution-processed first signal and the second signal and output the output image signal.

The signal processing device may further include a signal analyzer configured to receive and analyze the upscaled and super resolution-processed first signal from the super resolution processor and the second signal from the frequency divider, wherein the signal analyzer may be configured to determine the mix proportion of the first signal and the mix proportion of the second signal based on the resolving power or resolution of the upscaled and super resolution-processed first signal and the resolving power or resolution of the second signal.

The mixer may be configured to output a combined output image signal based on the mix proportion of the first signal and the mix proportion of the second signal from the signal analyzer.

In response to the resolving power or resolution of the upscaled and super resolution-processed first signal being higher than the resolving power or resolution of the second signal, the mixer may be configured to output an output image signal in which the proportion of the first signal is higher than the proportion of the second signal.

In response to the resolving power or resolution of the upscaled and super resolution-processed first signal being lower than the resolving power or resolution of the second signal, the mixer may be configured to output an output image signal in which the proportion of the second signal is higher than the proportion of the first signal.

Another embodiment of the present disclosure provides an image display apparatus including a display; an image receiver configured to receive an input image signal from outside; and a signal processing device configured to process the input image signal and output an output image signal, wherein in response to the input image signal being an image signal input through an HDMI input terminal, the signal processing device may be configured to calculate a spatial frequency of the input image signal and perform a super resolution mode for upscaling and super resolution processing on part of the signal of which the spatial frequency is calculated.

In response to the input image signal being an image signal input through an HDMI input terminal connected to a set-top box, the signal processing device may be configured to perform the super resolution mode.

Yet another embodiment of the present disclosure provides an image display apparatus including a display; an image receiver configured to receive an input image signal from outside; and a signal processing device configured to process the input image signal and output an output image signal, wherein in response to a resolution of the input image signal being the same as a resolution of the display, the signal processing device may be configured to calculate a spatial frequency of the input image signal and perform a super resolution mode for upscaling and super resolution processing on part of the signal of which the spatial frequency is calculated.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an example of an internal block diagram of the image display apparatus;

FIG. 3 is an example of an internal block diagram of the signal processing device in FIG. 2.

FIG. 4A is a diagram showing a method of controlling a remote controller of FIG. 2;

FIG. 4B is an internal block diagram of the remote controller of FIG. 2;

FIG. 5 is a flowchart showing an operation of an image display apparatus according to an embodiment of the present disclosure;

FIG. 6A is a flowchart showing an operation of an image display apparatus according to another embodiment of the present disclosure.

FIG. 6B is a flowchart showing an operation of an image display apparatus according to another embodiment of the present disclosure.

FIG. 7 is an internal block diagram of a signal processing device according to an embodiment of the present disclosure; and

FIGS. 8A to 11 are diagrams referred to in the description of FIGS. 5 to 7.

### DETAILED DESCRIPTION OF THE EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

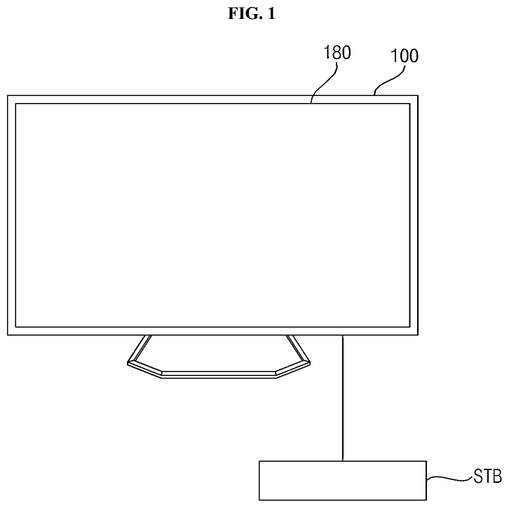

FIG. 1 is a diagram showing an image display apparatus according to an embodiment of the present disclosure.

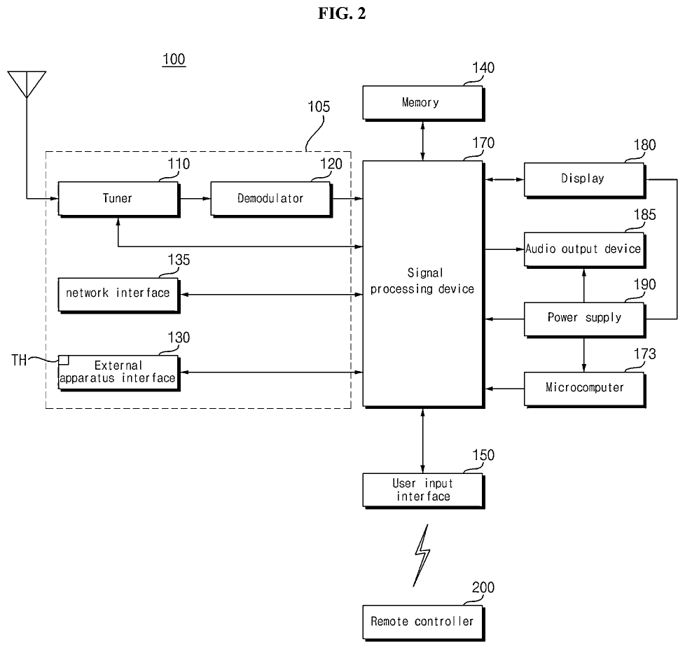

Referring to FIG. 1, an image display apparatus 100 according to an embodiment of the present disclosure may include a display 180, an image receiver (105 of FIG. 2) that externally receives an input image signal, and a signal processing device (170 of FIG. 2) configured to process the input image signal and output an output image signal to the display 180.

The display 180 may be implemented by one of various panels. For example, the display 180 may be one of a liquid crystal panel (LCD panel), an organic light-emitting panel (OLED panel), an inorganic light-emitting panel (LED panel), etc.

The image display apparatus 100 may be connected to a set-top box STB, and may be configured to receive a broadcast signal or an image signal through the set-top box STB.

The image display apparatus 100 may be configured to receive a broadcast signal through an internal tuner (110 of FIG. 2).

The image display apparatus 100 may externally receive an image signal over a wired or wireless network.

The image display apparatus 100 may be configured to receive an image signal from a connected external device.

In this case, the external device may be a set-top box STB, a mobile terminal, a USB-type storage device or tablet, or an HDMI-connected set-top box or laptop.

The image display apparatus 100 of FIG. 1 may be a TV, a monitor, a tablet PC, a mobile terminal, or the like.

FIG. 2 is an example of an internal block diagram of the image display apparatus of FIG. 1.

Referring to FIG. 2, the image display apparatus 100 according to an embodiment of the present disclosure includes an image receiver 105, an external apparatus interface 130, a memory 140, a user input interface 150, a sensor device, a signal processing device 170, a display 180, and an audio output device 185.

The image display apparatus 100 according to an embodiment of the present disclosure may further include a power supply 190 and a microcomputer 173.

The image receiver 105 may include a tuner 110, a demodulator 120, a network interface 135, and an external apparatus interface 130.

Meanwhile, as a variation, the image receiver 105 may include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna. In addition, the selected RF broadcast signal is converted into an intermediate frequency signal, a baseband image, or an audio signal.

For example, if the selected RF broadcast signal is a digital broadcast signal, the tuner 110 converts the digital broadcast signal into a digital IF (DIF) signal and, if the selected RF broadcast signal is an analog broadcast signal, the tuner 110 converts the analog broadcast signal into an analog baseband image or voice (CVBS/SIF) signal. That is, the tuner 110 may process a digital broadcast signal or an analog broadcast signal. The analog baseband image or voice (CVBS/SIF) signal output from the tuner 110 may be directly input to the signal processing device 170.

The tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may be configured to perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and output audio to the audio output device 185.

The external apparatus interface 130 may transmit or receive data with a connected external apparatus, e.g., a set-top box 50. To this end, the external apparatus interface 130 may include an A/V input and output device.

The external apparatus interface 130 may be connected in wired or wirelessly to an external apparatus, such as a digital versatile disk (DVD), a Blu ray, a game equipment, a camera, a camcorder, a computer (note book), and a set-top box, and may be configured to perform an input/output operation with an external apparatus.

The external apparatus interface 130 may include an HDMI input terminal TH or USB terminal for connecting to a set-top box STB or the like.

The A/V input and output device may be configured to receive image and audio signals from outside apparatus. Meanwhile, a wireless transceiver may be configured to perform short-range wireless communication with other electronic apparatus.

Through the wireless transceiver, the external apparatus interface 130 may exchange data with an adjacent mobile terminal 600. In particular, in a mirroring mode, the external apparatus interface 130 may be configured to receive device information, executed application information, application image, and the like from the mobile terminal 600.

The network interface 135 provides an interface for connecting the image display apparatus 100 to a wired/wireless network including the Internet network. For example, the network interface 135 may be configured to receive, via the network, content or data provided by the Internet, a content provider, or a network operator.

The network interface 135 may include a wireless transceiver.

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The user input interface 150 transmits a signal input by the user to the signal processing device 170 or transmits a signal from the signal processing device 170 to the user.

For example, it may transmit/receive a user input signal, such as power on/off, channel selection, screen setting, etc., from a remote controller 200, may transfer a user input signal input from a local key, such as a power key, a channel key, a volume key, a set value, etc., to the signal processing device 170, may transfer a user input signal input from a sensor device that senses a user's gesture to the signal processing device 170, or may transmit a signal from the signal processing device 170 to the sensor device.

The signal processing device 170 may demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

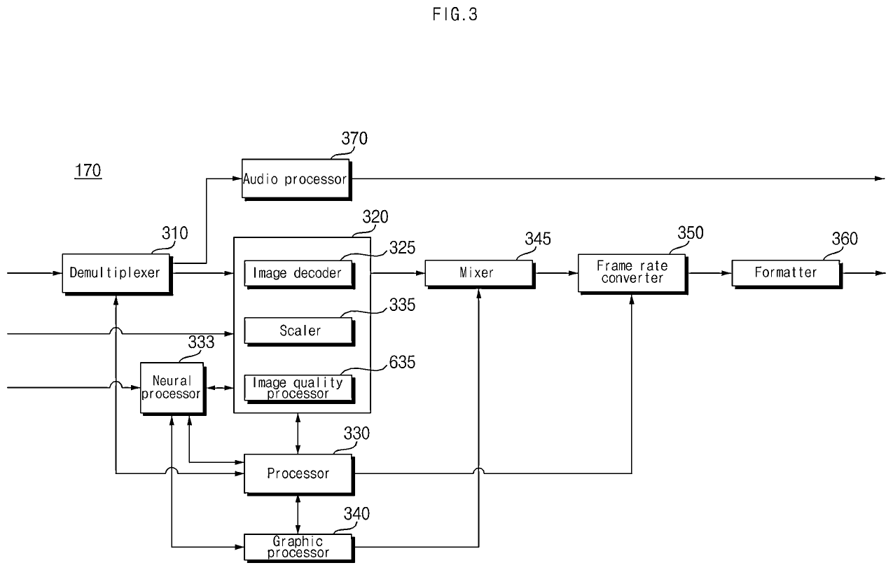

The signal processing device 170 may include a demultiplexer, an image processor, and the like. That is, the signal processing device 170 may be configured to perform a variety of signal processing and thus it may be implemented in the form of a system on chip (SOC). This will be described later with reference to FIG. 3.

In addition, the signal processing device 170 may be configured to control the overall operation of the image display apparatus 100. For example, the signal processing device 170 may be configured to control the tuner 110 to control the tuning of the RF broadcast corresponding to the channel selected by the user or the previously stored channel.

In addition, the signal processing device 170 may be configured to control the image display apparatus 100 according to a user command input through the user input interface 150 or an internal program.

The signal processing device 170 may be configured to control the display 180 to display an image. At this time, the image displayed on the display 180 may be a still image or a moving image, and may be a 2D image or a 3D image.

The signal processing device 170 may display a certain object in an image displayed on the display 180. For example, the object may be at least one of a connected web screen (newspaper, magazine, etc.), an electronic program guide (EPG), various menus, a widget, an icon, a still image, a moving image, and a text.

The signal processing device 170 may recognize the position of the user based on the image photographed by a photographing device. For example, the distance (z-axis coordinate) between a user and the image display apparatus 100 may be determined. In addition, the x-axis coordinate and the y-axis coordinate in the display 180 corresponding to a user position may be determined.

The display 180 generates a driving signal by converting an image signal, a data signal, an OSD signal, a control signal processed by the signal processing device 170, an image signal, a data signal, a control signal, and the like received from the external apparatus interface 130.

The display 180 may be configured as a touch screen and used as an input device in addition to an output device.

The audio output device 185 receives a signal processed by the signal processing device 170 and output it as an audio.

The photographing device photographs a user. The photographing device may be implemented by a single camera, but the present disclosure is not limited thereto and may be implemented by a plurality of cameras. Image information photographed by the photographing device may be input to the signal processing device 170.

The signal processing device 170 may sense a gesture of the user based on each of the images photographed by the photographing device, the signals detected from the sensor device, or a combination thereof.

The power supply 190 supplies corresponding power to the image display apparatus 100. Particularly, the power may be supplied to a signal processing device 170 which may be implemented in the form of a system on chip (SOC), a display 180 for displaying an image, and an audio output device 185 for outputting an audio.

Specifically, the power supply 190 may include an ac/dc converter for converting an alternating current voltage to a direct current voltage and a dc/dc converter for converting the level of direct current voltage.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may be configured to receive the image, audio, or data signal output from the user input interface 150, and display it on the remote controller 200 or output it as an audio.

The image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to FIG. 3, the signal processing device 170 according to an embodiment of the present disclosure may include a demultiplexer 310, an image processor 320, a processor 330, and an audio processor 370. In addition, the signal processing device 170 may further include and a data processor.

The demultiplexer 310 demultiplexes the input stream. For example, when an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may be configured to perform signal processing on an input image. For example, the image processor 320 may be configured to perform image processing on an image signal demultiplexed by the demultiplexer 310.

To this end, the image processor 320 may include an image decoder 325, a scaler 335, an image quality processor 635, an image encoder, a Graphic processor 340, a frame rate converter 350, a formatter 360, etc.

The image decoder 325 decodes a demultiplexed image signal, and the scaler 335 performs scaling so that the resolution of the decoded image signal may be output from the display 180.

The image decoder 325 may include a decoder of various standards. For example, an MPEG-2 decoder, an H.264 decoder, a 3D image decoder for a color image and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may be configured to perform image quality processing on an input image signal decoded by the image decoder 325 or the like.

For example, the image quality processor 635 may be configured to perform noise reduction processing on an input image signal, extend the high grayscale resolution of the input image signal, perform image resolution enhancement, perform high dynamic range (HDR)-based signal processing, vary frame rates, and perform image quality processing suitable for properties of a panel.

The graphic processor 340 generates an OSD signal according to a user input or by itself. For example, based on a user input signal, the Graphic processor 340 may generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the Graphic processor 340 may generate a pointer that may be displayed on the display, based on a pointing signal input from the remote controller 200. In particular, such a pointer may be generated by a pointing signal processing device, and the Graphic processor 340 may include such a pointing signal processing device. Obviously, the pointing signal processing device may be provided separately from the Graphic processor 340.

The frame rate converter (FRC) 350 may be configured to convert a frame rate of an input image. The frame rate converter 350 may be configured to output the input image without converting the frame rate.

The formatter 360 may change a format of an input image signal into a format suitable for displaying the image signal on a display and output the image signal in the changed format.

In particular, the formatter 360 may change a format of an image signal to correspond to a display panel.

Further, the formatter 360 may be configured to convert the format of an image signal. For example, the formatter 360 may be configured to convert the format of a 3D image signal into one of various 3D formats, including a side-by-side format, a top/down format, a frame sequential format, an interlaced format, a checker box format, etc.

The processor 330 may be configured to control overall operations of the image display apparatus 100 or the signal processing device 170.

For example, the processor 330 may be configured to control the tuner 110 to control the tuning of an RF broadcast corresponding to a channel selected by a user or a previously stored channel.

In addition, the processor 330 may be configured to control the image display apparatus 100 according to a user command input through the user input interface 150 or an internal program.

In addition, the processor 330 may transmit data to the network interface 135 or to the external apparatus interface 130.

In addition, the processor 330 may be configured to control the demultiplexer 310, the image processor 320, and the like in the signal processing device 170.

The audio processor 370 in the signal processing device 170 may be configured to perform the audio processing of the demultiplexed audio signal. To this end, the audio processor 370 may include various decoders.

In addition, the audio processor 370 in the signal processing device 170 may process a base, a treble, a volume control, and the like.

The data processor in the signal processing device 170 may be configured to perform data processing of the demultiplexed data signal. For example, when the demultiplexed data signal is a coded data signal, it may be decoded. The encoded data signal may be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may be provided separately in addition to the image processor 320.

The signal processing device 170 according to an embodiment of the present disclosure may further include a neural processor 333 for a learning process or the like.

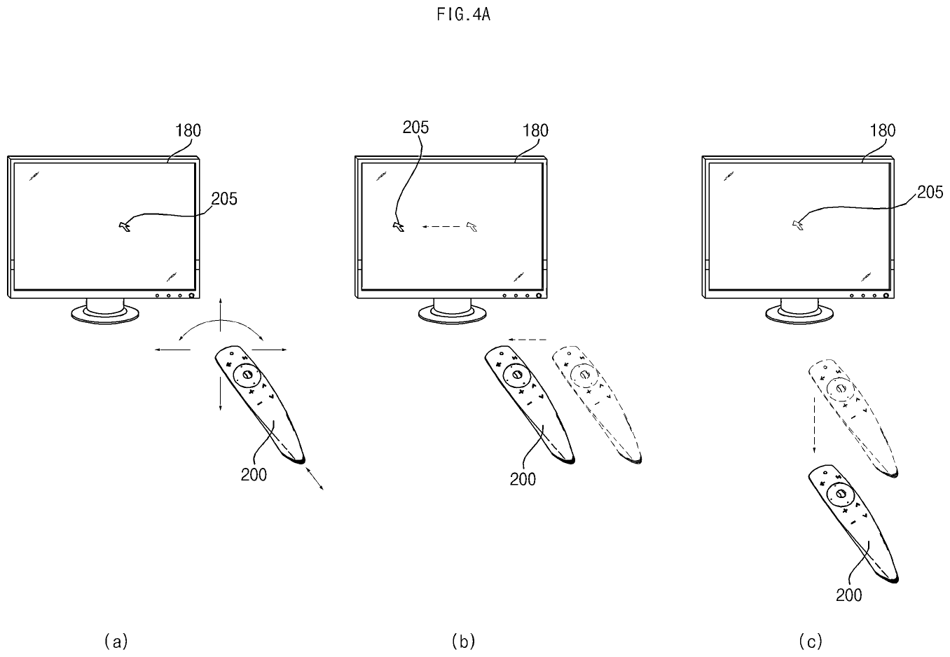

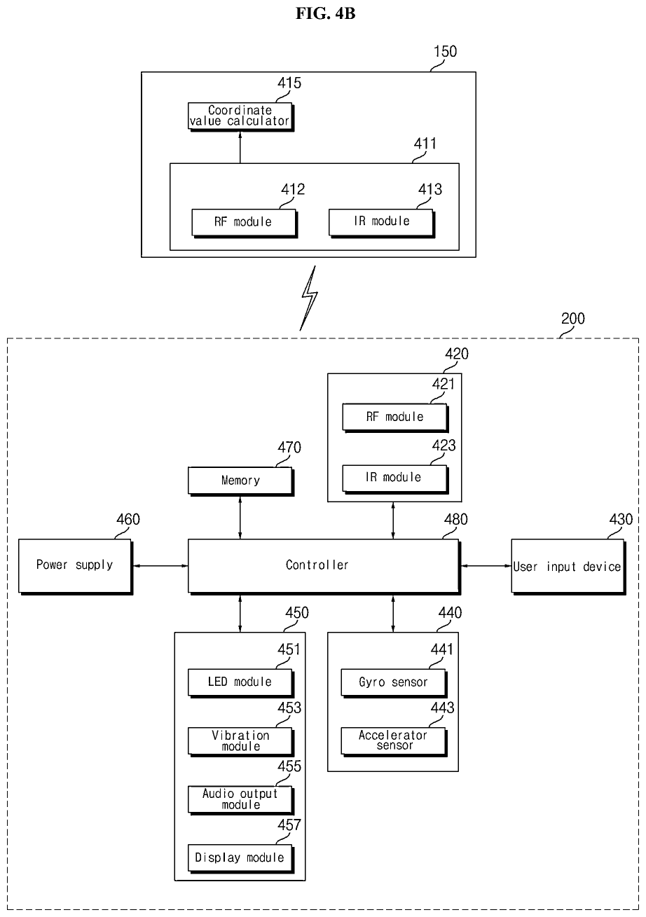

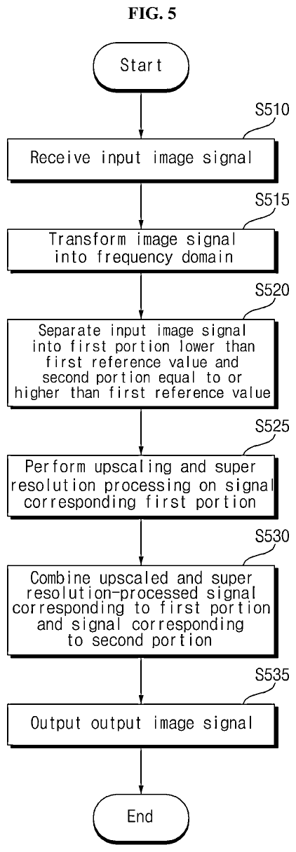

FIG. 4A is a diagram illustrating a control method of a remote controller of FIG. 2.

As shown in FIG. 4A (a), it is illustrated that a pointer 205 corresponding to the remote controller 200 is displayed on the display 180.

The user may move or rotate the remote controller 200 up and down, left and right (FIG. 4A (b)), and back and forth (FIG. 4A (c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A (b) illustrates that when the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A (c) illustrates a case where the user moves the remote controller 200 away from the display 180, while pressing a specific button of the remote controller 200. Thus, a selection area within the display 180 corresponding to the pointer 205 may be zoomed in so that it may be displayed to be enlarged. Meanwhile, when the user moves the remote controller 200 close to the display 180, the selection area within the display 180 corresponding to the pointer 205 may be zoomed out so that it may be displayed to be reduced. Meanwhile, when the remote controller 200 moves away from the display 180, the selection area may be zoomed out, and when the remote controller 200 approaches the display 180, the selection area may be zoomed in.

Meanwhile, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

The moving speed or the moving direction of the pointer 205 may correspond to the moving speed or the moving direction of the remote controller 200.

FIG. 4B is an internal block diagram of the remote controller of FIG. 2.

Referring to FIG. 4B, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may be configured to receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. When the user input device 435 includes a hard key button, the user may input a command related to the image display apparatus 100 to the remote controller 200 through a push operation of the hard key button. When the user input device 435 includes a touch screen, the user may touch a soft key of the touch screen to input the command related to the image display apparatus 100 to the remote controller 200. In addition, the user input device 435 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may be configured to output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on when the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. When the remote controller 200 is not moved for a certain time, the power supply 460 may stop the supply of power to reduce a power waste. The power supply 460 may resume power supply when a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may be configured to receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may be configured to determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of hand shake or error.

For another example, the coordinate value calculator 415 may be provided in the signal processing device 170, not in the user input interface 150.

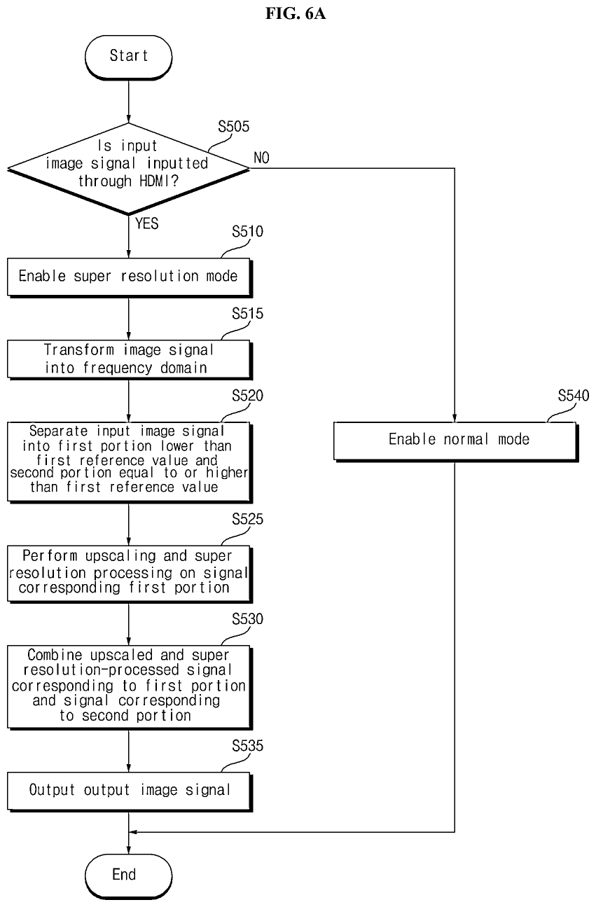

FIG. 5 is a flowchart showing an operation of an image display apparatus according to an embodiment of the present disclosure.

Referring to FIG. 5, the image receiver 105 in the image display apparatus 100 according to an embodiment of the present disclosure externally receives an input image signal (S510).

For example, the image receiver 105 in the image display apparatus 100 may be configured to receive an input image signal from outside device such as a set-top box STB or a USB device.

As another example, the image receiver 105 in the image display apparatus 100 may be configured to receive an input image signal corresponding a broadcast signal through the tuner 110.

As yet another example, the image receiver 105 in the image display apparatus 100 may be configured to receive an input image signal from outside mobile terminal through wireless communication.

The signal processing device 170 receives an input image signal from the image receiver 105.

Next, the signal processing device 170 is configured to calculate the spatial frequency of at least part of the input image signal on a pixel basis (S515).

Next, the signal processing device 170 is configured to extract a first signal SGL and a second signal SGH having a higher spatial frequency than the first signal SGL from the input image signal based on the calculated spatial frequency (S520).

For example, the signal processing device 170 may be configured to extract a first signal SGL from the input image signal in response to the calculated spatial frequency being lower than a first reference spatial frequency, and extract a second signal SGH from the input image signal in response to the calculated spatial frequency being equal to or higher than the first reference spatial frequency.

In this case, the first signal SGL may be termed a low-frequency signal, and the second signal SGH may be termed a high-frequency signal.

Next, the signal processing device 170 performs upscaling and super resolution processing on the first signal SGL (S525).

That is, the signal processing device 170 upscales the first signal SGL which is a low-frequency signal. Accordingly, it is possible to increase the resolving power or resolution of the first signal SGL which is a low-frequency signal.

In this case, the resolving power may have a meaning that includes resolution or the like.

The signal processing device 170 may be configured to perform super resolution processing on the upscaled first signal SGL.

For example, the signal processing device 170 may be configured to perform super resolution processing on a texture in the upscaled first signal SGL.

As another example, the signal processing device 170 may be configured to perform super resolution processing on an edge in the upscaled first signal SGL.

The upscaled and super resolution-processed first signal SGL may enhance sharpness and reduce noise, compared to before the upscaling.

The signal processing device 170 may not perform signal processing, such as upscaling, of the second signal SGH which is a high-frequency signal.

Next, the signal processing device 170 combines the upscaled and super resolution-processed first signal SGL and the second signal SGH which is not upscaled (S530).

Then, the signal processing device 170 outputs a combined signal as an output image signal (S535).

In this way, it is possible to reduce noise, degradation, etc. present in a low-frequency portion of an input image signal by converting the spatial frequency of the input image signal, separating the input image signal into a first signal SGL and a second signal SGH having a higher spatial frequency than the first signal SGL based on the calculated spatial frequency, and performing upscaling and super resolution processing on the first signal SGL. As a result, the picture quality of the input image can be stably improved.

Meanwhile, if the resolving power or resolution of the upscaled and super resolution-processed first signal SGL is higher than the resolving power or resolution of the second signal SGH, the signal processing device 170 may be configured to output an output image signal in which the proportion of the first signal SGL is higher than the proportion of the second signal SGH. Accordingly, it is possible to stably improve the picture quality of the input image.

On the other hand, if the resolving power or resolution of the upscaled and super resolution-processed first signal SGL is lower than the resolving power or resolution of the second signal SGH, the signal processing device 170 may be configured to output an output image signal in which the proportion of the second signal SGH is higher than the proportion of the first signal SGL. Accordingly, it is possible to stably improve the picture quality of the input image.

According to FIG. 5, the signal processing device 170 according to an embodiment of the present disclosure is configured to calculate the spatial frequency of at least part of an input image signal on a pixel basis, extract a first signal SGL and a second signal SGH having a higher spatial frequency than the first signal SGL from the input image signal based on the calculated spatial frequency, perform upscaling and super resolution processing on the first signal SGL, and output an output image signal based on the upscaled and super resolution-processed first signal SGL and the second signal SGH.

Accordingly, it is possible to stably improve the picture quality of an input image. Also, it is possible to stably improve picture quality while maintaining the resolving power of an input image. Further, it is possible to stably improve picture quality while reducing degradation of an upscaled input image, since low resolution region and high resolution region in the input image can be processed separately.

Meanwhile, in a case where the set-top box STB upscales an image with a first resolution to produce an image with a second resolution, the picture quality of the input image can be stably improved by the operation method in FIG. 5.

For example, when the set-top box STB upscales an image with a first resolution to produce an image with a second resolution, the resolution of the original image may be deteriorated.

On the other hand, when the set-top box STB performs upscaling but does not output upscaling information, the image display apparatus 100 receives an input image signal with degradation of the resolution of the original image.

That is, even if it receives an upscaled input image signal, the signal processing device 170 according to an embodiment of the present disclosure is configured to calculate the spatial frequency of at least part of the input image signal on a pixel basis, extract a first signal SGL and a second signal SGH having a higher spatial frequency than the first signal SGL from the input image signal based on the calculated spatial frequency, perform upscaling and super resolution processing on the first signal SGL, and output an output image signal based on the upscaled and super resolution-processed first signal SGL and the second signal SGH. Thus, it is possible to stably improve picture quality while reducing degradation of the upscaled input image.

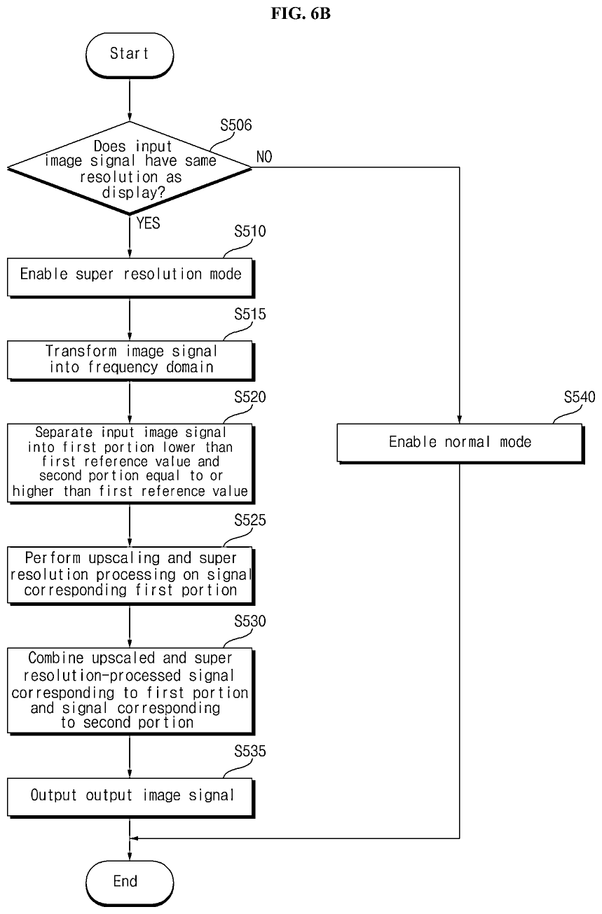

FIG. 6A is a flowchart showing an operation of an image display apparatus according to another embodiment of the present disclosure.

Referring to FIG. 6A, the steps S515 to S535 of FIG. 6A are identical to those in FIG. 5, so descriptions of them will be omitted.

The signal processing device 170 is configured to determine whether an input image signal is an image signal input through an HDMI input terminal TH (S505), and, if so, perform a super resolution mode for upscaling and super resolution processing (S510).

For example, in a case where a set-top box STB is connected to the HDMI input terminal TH and an input image signal from the set-top box STB is received through the HDMI input terminal TH, the signal processing device 170 may be configured to perform the super resolution mode.

In particular, when the set-top box STB is connected to the HDMI input terminal TH and an upscaled input image signal from the set-top box STB is received through the HDMI input terminal TH, the signal processing device 170 may be configured to perform the super resolution mode.

Meanwhile, according to the super resolution mode, the steps S515 to S535 in FIG. 5 may be performed. Accordingly, it is possible to stably improve picture quality while reducing degradation of an upscaled input image.

On the other hand, in the step S505, in response to the input image signal not being the image signal input through the HDMI input terminal TH, the signal processing device 170 may be configured to perform not the super resolution mode but a normal mode for signal processing (S540).

As used herein, the super resolution mode may refer to a mode in which super resolution processing is performed on an upscaled signal, and the normal mode may refer to a mode in which signal processing is performed on a non-upscaled signal.

For example, according to the normal mode, the signal processing device 170 may be configured to remove noise from the input image signal or perform image quality processing to improve gray-level resolution, resolution, or sharpness, without separating the input image signal into a low-frequency signal and a high-frequency signal based on spatial frequency conversion. Accordingly, it is possible to perform image quality processing according to the normal mode.

As another example, according to the normal mode, the signal processing device 170 may be configured to perform super resolution processing on the entire input image signal. Accordingly, it is possible to perform image quality processing according to the normal mode.

As yet another example, according to the normal mode, the signal processing device 170 may be configured to perform super resolution processing on the input image signal based on spatial frequency conversion. Accordingly, it is possible to perform image quality processing according to the normal mode.

As a result, referring to FIG. 6, in response to the input image signal being an image signal input through an HDMI input terminal TH, the signal processing device 170 according to another embodiment of the present disclosure may be configured to calculate a spatial frequency of the input image signal and enable the super resolution mode for upscaling and super resolution processing on part of the signal of which the spatial frequency is calculated.

Accordingly, it is possible to stably improve the picture quality of an input image. Also, it is possible to stably improve picture quality while maintaining the resolving power of an input image. Further, it is possible to stably improve picture quality while reducing degradation of an upscaled input image

Meanwhile, in response to the input image signal being an image signal input through an HDMI input terminal TH connected to a set-top box STB, the signal processing device 170 may be configured to perform the super resolution mode. Accordingly, it is possible to stably improve the picture quality of an input image inputted from the set-top box STB.

FIG. 6B is a flowchart showing an operation of an image display apparatus according to another embodiment of the present disclosure.

Referring to FIG. 6B, the steps S515 to S535 of FIG. 6B are identical to those in FIG. 5, so descriptions of them will be omitted.

The signal processing device 170 is configured to determine whether the resolution of an input image signal and the resolution of the display 180 are the same (S506), and, if so, perform a super resolution mode for upscaling and super resolution processing (S510).

For example, in a case where a set-top box STB outputs an upscaled image signal so as to have the same resolution as the display 180, the signal processing device 170 normally may not perform upscaling or the like since the resolution of the input image signal and the resolution of the display 180 are the same.

However, the upscaled input image signal from the set-top box STB may deteriorate the resolving power of the original image.

In this regard, in the present disclosure, in response to the resolution of the input image signal being the same as the resolution of the display 180 are the same, the super resolution mode is immediately enabled.

Meanwhile, according to the super resolution mode, the steps S515 to S535 of FIG. 6B may be performed. Accordingly, it is possible to stably improve picture quality while reducing degradation of an upscaled input image.

On the other hand, in the step S505, in response to the resolution of the input image signal being different from the resolution of the display 180, the signal processing device 170 may be configured to perform not the super resolution mode but a normal mode for signal processing (S540).

For example, according to the normal mode, the signal processing device 170 may be configured to remove noise from the input image signal or perform image quality processing to improve gray-level resolution, resolution, or sharpness, without separating the input image signal into a low-frequency signal and a high-frequency signal based on spatial frequency conversion. Accordingly, it is possible to perform image quality processing according to the normal mode.

As another example, according to the normal mode, the signal processing device 170 may be configured to perform super resolution processing on the entire input image signal. Accordingly, it is possible to perform image quality processing according to the normal mode.

As yet another example, according to the normal mode, the signal processing device 170 may be configured to perform super resolution processing on the input image signal based on spatial frequency conversion. Accordingly, it is possible to perform image quality processing according to the normal mode.

Meanwhile, according to FIG. 6B, if the resolution of the input image signal received from the set-top box STB is a first resolution and the resolution of the display 180 is the first resolution, the signal processing device 170 may be configured to calculate a spatial frequency of the input image signal on a pixel basis, extract a first signal SGL and a second signal SGH having a higher spatial frequency than the first signal SGL from the input image signal based on the calculated spatial frequency, perform upscaling and super resolution processing on the first signal SGL, and output an output image signal based on the upscaled and super resolution-processed first signal SGL and the second signal SGH. Accordingly, it is possible to stably improve the picture quality of an input image.

That is, in response to a resolution of the input image signal being the same as a resolution of the display 180, the signal processing device 170 according to yet another embodiment of the present disclosure is configured to calculate the spatial frequency of the input image signal and perform a super resolution mode for upscaling and super resolution processing on part of the signal of which the spatial frequency is calculated. Accordingly, it is possible to stably improve the picture quality of an input image. Also, it is possible to stably improve picture quality while maintaining the resolving power of an input image. Further, it is possible to stably improve picture quality while reducing degradation of an upscaled input image.

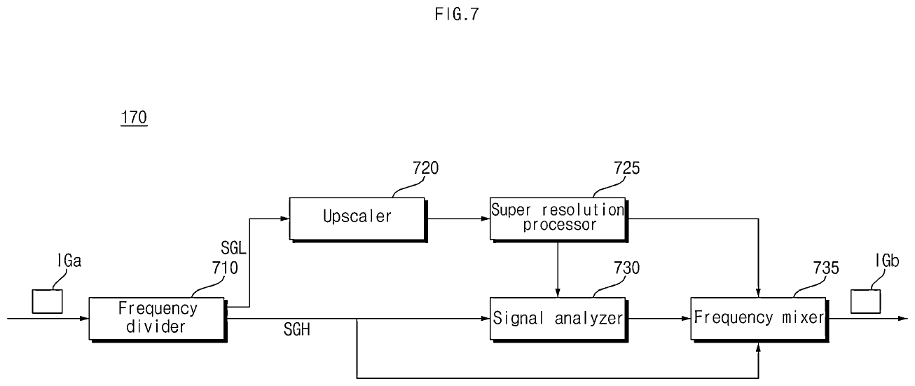

FIG. 7 is an internal block diagram of a signal processing device according to an embodiment of the present disclosure.

Referring to FIG. 7, the signal processing device 170 according to an embodiment of the present disclosure may include a frequency divider 710, an upscaler 720, a super resolution processor 725, and a mixer 735.

The frequency divider 710 may be configured to calculate a spatial frequency of an input image signal on a pixel basis, and extract a first signal SGL and a second signal SGH having a higher spatial frequency than the first signal SGL from the input image signal based on the calculated spatial frequency.

For example, the frequency divider 710 may be configured to extract the first signal from the input image signal SGL in response to the calculated spatial frequency being lower than a first reference spatial frequency and extract a second signal SGH from the input image signal in response to the calculated spatial frequency being equal to or higher than the first reference spatial frequency.

The upscaler 720 may be configured to receive the first signal SGL from the frequency divider 710 and perform upscaling on the first signal SGL. Accordingly, it is possible to increase the resolving power or resolution of the first signal SGL.

The super resolution processor 725 may be configured to perform super resolution processing on the upscaled first signal SGL from the upscaler 720. Accordingly, it is possible to enhance the sharpness of the first signal SGL and improve visual quality.

For example, the super resolution processor 725 may be configured to perform super resolution processing on texture in the upscaled first signal SGL.

As another example, the super resolution processor 725 may be configured to perform super resolution processing on an edge in the upscaled first signal SGL.

Next, the super resolution processor 735 may be configured to combine the upscaled and super resolution-processed first signal SGL and the second signal SGH and output an output image signal. Accordingly, it is possible to stably improve the picture quality of the input image.

The signal processing device 170 according to an embodiment of the present disclosure may further include a signal analyzer 730 that receives and analyzes the upscaled and super resolution-processed first signal SGL from the super resolution processor 725 and the second signal SGH from the frequency divider 710.

For example, the signal analyzer 730 may be configured to determine the mix proportion of the first signal SGL and the mix proportion of the second signal SGH based on the resolving power or resolution of the upscaled and super resolution-processed first signal SGL and the resolving power or resolution of the second signal SGH.

The signal analyzer 730 may analyze the magnitude of the second signal SGH which is a high-frequency signal and determine the mix proportion of the first signal SGL and the mix proportion of the second signal SGH so as to prevent degradation.

The mixer 735 may be configured to output a combined output image signal based on the mix proportion of the first signal SGL and the mix proportion of the second signal SGH from the signal analyzer 730.

Meanwhile, if the resolving power or resolution of the upscaled and super resolution-processed first signal SGL is higher than the resolving power or resolution of the second signal SGH, the mixer 735 may be configured to output an output image signal in which the proportion of the first signal SGL is higher than the proportion of the second signal SGH. Accordingly, it is possible to stably improve the picture quality of the input image.

On the other hand, if the resolving power or resolution of the upscaled and super resolution-processed first signal SGL is lower than the resolving power or resolution of the second signal SGH, the mixer 735 may be configured to output an output image signal in which the proportion of the second signal SGH is higher than the proportion of the first signal SGL. Accordingly, it is possible to stably improve the picture quality of the input image.

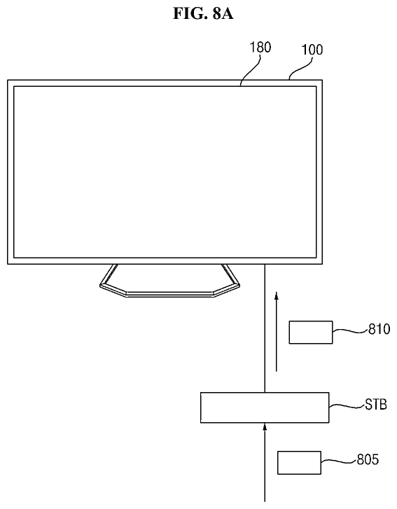

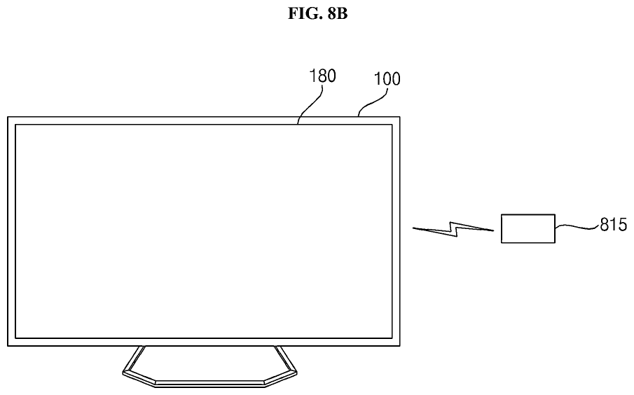

FIG. 8A illustrates that an upscaled image is outputted from a set-top box.

Referring to FIG. 8A, the set-top box STB may upscale an image 805 with a first resolution to produce an image 810 with a second resolution which is higher than the first resolution.

In response to this, the image receiver 105 of the image display apparatus 100 may be configured to receive an input image signal corresponding to the second-resolution image 810 from the set-top box STB.

The signal processing apparatus 170 according to an embodiment of the present disclosure may be configured to perform the super resolution mode upon receiving an input image signal corresponding to the second resolution image 810 from the set-top box STB.

That is, the signal processing device 170 according to an embodiment of the present disclosure is configured to calculate the spatial frequency of at least part of an input image signal corresponding to the second-resolution image 810 on a pixel basis, extract a first signal SGL and a second signal SGH having a higher spatial frequency than the first signal SGL from the input image signal based on the calculated spatial frequency, perform upscaling and super resolution processing on the first signal SGL, and output an output image signal based on the upscaled and super resolution-processed first signal SGL and the second signal SGH.

Accordingly, it is possible to stably improve the picture quality of an input image. Also, it is possible to stably improve picture quality while maintaining the resolving power of an input image. Further, it is possible to stably improve picture quality while reducing degradation of an upscaled input image, since low resolution region and high resolution region in the input image can be processed separately.

FIG. 8B illustrates that an input image signal is wirelessly received by an image display apparatus.

Referring to FIG. 8B the image receiver 105 in the image display apparatus 100 may be configured to receive an input image signal 815 which is a broadcast signal through the tuner 110 or receive an input image signal 815 wirelessly via the network interface 136.

The signal processing device 170 according to an embodiment of the present disclosure may enable the normal mode, not the super resolution mode, upon receiving an input image signal 815 which is a broadcast signal through the tuner 110, or upon receiving an input image signal 815 wirelessly via the network interface 135.

For example, according to the normal mode, the signal processing device 170 may be configured to remove noise from the input image signal 815 or perform image quality processing to improve gray-level resolution, resolution, or sharpness, without separating the input image signal 815 into a low-frequency signal and a high-frequency signal based on spatial frequency conversion. Accordingly, it is possible to perform image quality processing according to the normal mode.

As another example, according to the normal mode, the signal processing device 170 may be configured to perform super resolution processing on the entire input image signal 815. Accordingly, it is possible to perform image quality processing according to the normal mode.

As yet another example, according to the normal mode, the signal processing device 170 may be configured to perform super resolution processing on the input image signal 815 based on spatial frequency conversion. Accordingly, it is possible to perform image quality processing according to the normal mode.

On the other hand, as opposed to FIGS. 8A and 8B, the signal processing device 170 according to an embodiment of the present disclosure may enable the above-described super resolution mode if the resolution of the image display apparatus and the resolution of an input image are the same.

For example, as shown in FIG. 8, the signal processing device 170 may be configured to receive an image 810 from the set-top box STB, calculate a spatial frequency of the image 810 if the image 810 has the same resolution as the display 180, extract a first signal SGL and a second signal SGH having a higher spatial frequency than the first signal SGL from the input image signal based on the calculated spatial frequency, and perform upscaling and super resolution processing on the first signal SGL. Accordingly, it is possible to stably improve the picture quality of the input image.

As another example, as shown in FIG. 8B, the signal processing device 170 may be configured to receive an input image signal 815, which is a broadcast signal, through the tuner 110 or receive an input image signal 815 wirelessly via the network interface 135, calculate a spatial frequency of the image 815 if the received input image signal 815 has the same resolution as the display 180, extract a first signal SGL and a second signal SGH having a higher spatial frequency than the first signal SGL from the input image signal 815 based on the calculated spatial frequency, and perform upscaling and super resolution processing on the first signal SGL. Accordingly, it is possible to stably improve the picture quality of the input image.

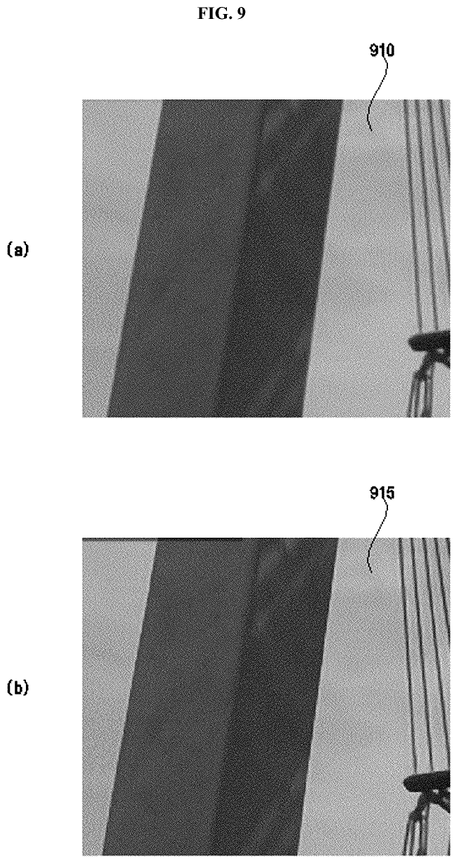

FIG. 9 illustrates an example of an image based on the super resolution mode.

Referring to the drawings, (a) of FIG. 9 depicts an image 910 to which the super resolution mode is not applied, and (b) of FIG. 9 depicts an image 915 to which the super resolution mode is applied.

For example, (a) of FIG. 9 may depict an input image 910 that is fed into the signal processing device 170.

The signal processing device 170 may be configured to calculate a spatial frequency of at least part of the input image 910 on a pixel basis, extract into a first signal SGL and a second signal SGH having a higher spatial frequency than the first signal SGL from the input image signal based on the calculated spatial frequency, perform upscaling and super resolution processing on the first signal SGL, and output an output image 915 as shown in (b) of FIG. 9 based on the upscaled and super resolution-processed first signal SGL and the second signal SGH.

The image 915 in (b) of FIG. 9 shows better sharpness compared to the image 910 in (a) of FIG. 9, particularly in texture and on the edges.

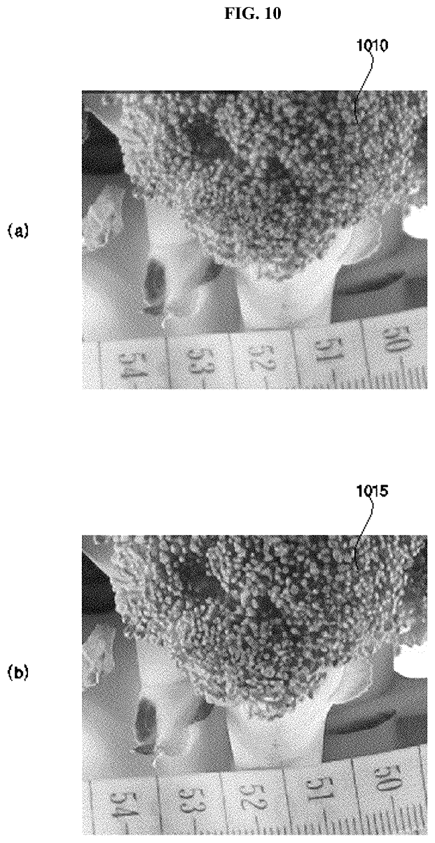

FIG. 10 illustrates another example of an image based on the super resolution mode.

Referring to the drawings, (a) of FIG. 10 depicts an image 1010 to which the super resolution mode is not applied, and (b) of FIG. 10 depicts an image 1015 to which the super resolution mode is applied.

For example, (a) of FIG. 10 may depict an input image 1010 that is fed into the signal processing device 170.

The signal processing device 170 may be configured to calculate a spatial frequency of at least part of the input image 1010 on a pixel basis, the input image signal a first signal SGL and a second signal SGH having a higher spatial frequency than the first signal SGL from the input image signal based on the calculated spatial frequency, perform upscaling and super resolution processing on the first signal SGL, and output an output image 1015 as shown in (b) of FIG. 10 based on the upscaled and super resolution-processed first signal SGL and the second signal SGH.

The image 1015 in (b) of FIG. 10 shows better sharpness compared to the image 1010 in (a) of FIG. 10, particularly in text such as numbers.

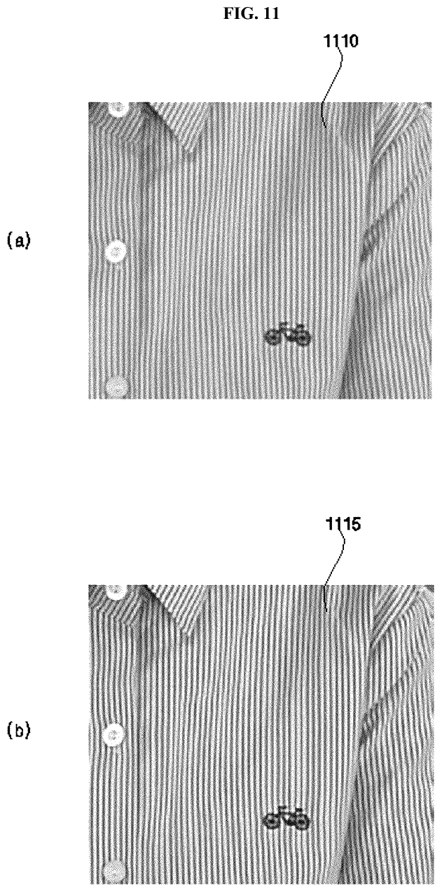

FIG. 11 illustrates yet another example of an image based on the super resolution mode.

Referring to the drawings, (a) of FIG. 11 depicts an image 1110 to which the super resolution mode is not applied, and (b) of FIG. 11 depicts an image 1115 to which the super resolution mode is applied.

For example, (a) of FIG. 11 may depict an input image 1110 that is fed into the signal processing device 170.

The signal processing device 170 may be configured to calculate a spatial frequency of at least part of the input image 1110 on a pixel basis, extract a first signal SGL and a second signal SGH having a higher spatial frequency than the first signal SGL from the input image signal based on the calculated spatial frequency, perform upscaling and super resolution processing on the first signal SGL, and output an output image 1115 as shown in (b) of FIG. 11 based on the upscaled and super resolution-processed first signal SGL and the second signal SGH.

The image 1115 in (b) of FIG. 11 shows better sharpness compared to the image 1110 in (a) of FIG. 11, particularly on the edges.

As described above, an image display apparatus according to an embodiment of the present disclosure may include a display; an image receiver configured to receive an input image signal from outside; and a signal processing device configured to process the input image signal and output an output image signal, wherein the signal processing device is configured to calculate a spatial frequency of at least part of the input image signal on a pixel basis, extract a first signal and a second signal having a higher spatial frequency from the input image signal based on the calculated spatial frequency, perform upscaling and super resolution processing on the first signal, and output an output image signal based on the upscaled and super resolution-processed first signal and the second signal. Accordingly, it is possible to stably improve the picture quality of an input image. Also, it is possible to stably improve picture quality while maintaining the resolving power of an input image. Further, it is possible to stably improve picture quality while reducing degradation of an upscaled input image, since low resolution region and high resolution region in the input image can be processed separately.

The image receiver may be configured to receive the input image signal from a set-top box, and in response to the resolution of the input image signal received from the set-top box being a first resolution and the resolution of the display being the first resolution, the signal processing device may be configured to calculate a spatial frequency of the input image signal on a pixel basis, extract a first signal and a second signal having a higher spatial frequency from the input image signal than the first signal, based on the calculated spatial frequency, perform upscaling and super resolution processing on the first signal, and output an output image signal based on the upscaled and super resolution-processed first signal and the second signal. Accordingly, it is possible to stably improve the picture quality of an input image.

The signal processing device may be configured to extract the first signal from the input image signal in response to the calculated spatial frequency being lower than a reference spatial frequency, and extract the second signal from the input image signal in response to the calculated spatial frequency being equal to or higher than the reference spatial frequency. Accordingly, it is possible to stably improve the picture quality of an input image.

In response to the resolving power or resolution of the upscaled and super resolution-processed first signal being higher than the resolving power or resolution of the second signal, the signal processing device may be configured to output an output image signal in which the proportion of the first signal is higher than the proportion of the second signal. Accordingly, it is possible to stably improve the picture quality of an input image.

In response to the resolving power or resolution of the upscaled and super resolution-processed first signal being lower than the resolving power or resolution of the second signal, the signal processing device may be configured to output an output image signal in which the proportion of the second signal is higher than the proportion of the first signal. Accordingly, it is possible to stably improve the picture quality of an input image.

In response to the input image signal being an image signal input through an HDMI input terminal, the signal processing device may be configured to perform a super resolution mode for upscaling and super resolution processing. Accordingly, it is possible to stably improve the picture quality of an input image inputted through the HDMI input terminal.

In response to the input image signal not being the image signal input through the HDMI input terminal, the signal processing device may be configured to perform not the super resolution mode but a normal mode for signal processing. Accordingly, it is possible to perform image quality processing according to the normal mode.

In response to a resolution of the input image signal being the same as a resolution of the display, the signal processing device may be configured to perform a super resolution mode for upscaling and super resolution processing. Accordingly, it is possible to stably improve the picture quality of an input image.

In response to the resolution of the input image signal being different from the resolution of the display, the signal processing device may be configured to perform not the super resolution mode but a normal mode for signal processing. Accordingly, it is possible to perform image quality processing according to the normal mode.

The signal processing device may include: a frequency divider configured to calculate the spatial frequency of the input image signal on a pixel basis and extract the first signal and the second signal having a higher spatial frequency from the input image signal based on the calculated spatial frequency; an upscaler configured to perform upscaling on the first signal; a super resolution processor configured to perform super resolution processing on the upscaled first signal; and a mixer configured to combine the upscaled and super resolution-processed first signal and the second signal and output the output image signal. Accordingly, it is possible to stably improve the picture quality of an input image.

The signal processing device may further include a signal analyzer configured to receive and analyze the upscaled and super resolution-processed first signal from the super resolution processor and the second signal from the frequency divider, wherein the signal analyzer may be configured to determine the mix proportion of the first signal and the mix proportion of the second signal based on the resolving power or resolution of the upscaled and super resolution-processed first signal and the resolving power or resolution of the second signal. Accordingly, it is possible to stably improve the picture quality of an input image.

The mixer may be configured to output a combined output image signal based on the mix proportion of the first signal and the mix proportion of the second signal from the signal analyzer. Accordingly, it is possible to stably improve the picture quality of an input image.

In response to the resolving power or resolution of the upscaled and super resolution-processed first signal being higher than the resolving power or resolution of the second signal, the mixer may be configured to output an output image signal in which the proportion of the first signal is higher than the proportion of the second signal. Accordingly, it is possible to stably improve the picture quality of an input image.

In response to the resolving power or resolution of the upscaled and super resolution-processed first signal being lower than the resolving power or resolution of the second signal, the mixer may be configured to output an output image signal in which the proportion of the second signal is higher than the proportion of the first signal. Accordingly, it is possible to stably improve the picture quality of an input image.

An image display apparatus according to another embodiment of the present disclosure may include a display; an image receiver configured to receive an input image signal from outside; and a signal processing device configured to process the input image signal and output an output image signal, wherein in response to the input image signal being an image signal input through an HDMI input terminal, the signal processing device may be configured to calculate a spatial frequency of the input image signal and perform a super resolution mode for upscaling and super resolution processing on part of the signal of which the spatial frequency is calculated. Accordingly, it is possible to stably improve the picture quality of an input image. Also, it is possible to stably improve picture quality while maintaining the resolving power of an input image. Further, it is possible to stably improve picture quality while reducing degradation of an upscaled input image.

In response to the input image signal being an image signal input through an HDMI input terminal connected to a set-top box, the signal processing device may be configured to perform the super resolution mode. Accordingly, it is possible to stably improve the picture quality of an input image inputted from the set-top box.

An image display apparatus according to yet another embodiment of the present disclosure may include a display; an image receiver configured to receive an input image signal from outside; and a signal processing device configured to process the input image signal and output an output image signal, wherein in response to a resolution of the input image signal being the same as a resolution of the display, the signal processing device may be configured to calculate a spatial frequency of the input image signal and perform a super resolution mode for upscaling and super resolution processing on part of the signal of which the spatial frequency is calculated. Accordingly, it is possible to stably improve the picture quality of an input image. Also, it is possible to stably improve picture quality while maintaining the resolving power of an input image. Further, it is possible to stably improve picture quality while reducing degradation of an upscaled input image.

While the disclosure has been described with reference to the embodiments, the disclosure is not limited to the above-described specific embodiments, and it will be understood by those skilled in the related art that various modifications and variations may be made without departing from the scope of the disclosure as defined by the appended claims, as well as these modifications and variations should not be understood separately from the technical spirit and prospect of the disclosure.

What is claimed is:

1. An image display apparatus comprising:
a display;
an image receiver configured to receive an input image signal from an outside of the image display apparatus; and
a signal processing device configured to process the input image signal and output an output image signal, the signal processing device being configured to:
calculate a spatial frequency of at least part of the input image signal on a pixel basis,
extract a first signal and a second signal having a higher spatial frequency than the first signal, from the input image signal based on the calculated spatial frequency,
perform upscaling and super resolution processing on the first signal, and
output the output image signal based on the upscaled and super resolution-processed first signal and the second signal.

2. The image display apparatus of claim 1, wherein the image receiver is configured to receive the input image signal from a set-top box, and
in response to a resolution of the input image signal received from the set-top box being a first resolution and a resolution of the display being the first resolution, the signal processing device is configured to calculate the spatial frequency of the input image signal on the pixel basis, extract the first signal and the second signal having a higher spatial frequency than the first signal, from the input image signal based on the calculated spatial frequency, perform upscaling and super resolution processing on the first signal, and output the output image signal based on the upscaled and super resolution-processed first signal and the second signal.

3. The image display apparatus of claim 1, wherein the signal processing device is configured to extract the first signal from the input image signal in response to the calculated spatial frequency being lower than a reference spatial frequency, and extract the second signal from the input image signal in response to the calculated spatial frequency being equal to or higher than the reference spatial frequency.

4. The image display apparatus of claim 1, wherein in response to a resolving power or resolution of the upscaled and super resolution-processed first signal being higher than a resolving power or resolution of the second signal, the signal processing device is configured to output the output image signal in which a proportion of the first signal is higher than a proportion of the second signal.

5. The image display apparatus of claim 1, wherein in response to a resolving power or resolution of the upscaled and super resolution-processed first signal being lower than a resolving power or resolution of the second signal, the signal processing device is configured to output the output image signal in which a proportion of the second signal is higher than a proportion of the first signal.

6. The image display apparatus of claim 1, wherein in response to the input image signal being an image signal input through an HDMI input terminal, the signal processing device is configured to perform a super resolution mode for the upscaling and super resolution processing.

7. The image display apparatus of claim 6, wherein in response to the input image signal not being the input image signal input through the HDMI input terminal, the signal processing device is configured to perform a normal mode different than the super resolution mode for the upscaling and super resolution processing.

8. The image display apparatus of claim 1, wherein in response to a resolution of the input image signal being the same as a resolution of the display, the signal processing device is configured to perform a super resolution mode for the upscaling and super resolution processing.

9. The image display apparatus of claim 8, wherein in response to the resolution of the input image signal being different from the resolution of the display, the signal processing device is configured to perform a normal mode different than the super resolution mode for the upscaling and super resolution processing.

10. The image display apparatus of claim 1, wherein the signal processing device includes:
a frequency divider configured to calculate the spatial frequency of the input image signal on the pixel basis and extract the first signal and the second signal having a higher spatial frequency than the first signal, from the input image signal based on the calculated spatial frequency;
an upscaler configured to perform the upscaling on the first signal;
a super resolution processor configured to perform the super resolution processing on the upscaled first signal; and
a mixer configured to combine the upscaled and super resolution-processed first signal and the second signal and output the output image signal.

11. The image display apparatus of claim 10, wherein the signal processing device further includes a signal analyzer configured to receive and analyze the upscaled and super resolution-processed first signal from the super resolution processor and the second signal from the frequency divider,
wherein the signal analyzer is configured to determine a mix proportion of the first signal and a mix proportion of the second signal based on a resolving power or resolution of the upscaled and super resolution-processed first signal and a resolving power or resolution of the second signal.

12. The image display apparatus of claim 11, wherein the mixer is configured to output a combined output image signal based on the mix proportion of the first signal and the mix proportion of the second signal from the signal analyzer.

13. The image display apparatus of claim 11, wherein in response to the resolving power or resolution of the upscaled and super resolution-processed first signal being higher than the resolving power or resolution of the second signal, the mixer is configured to output the output image signal in which a proportion of the first signal is higher than a proportion of the second signal.

14. The image display apparatus of claim 11, wherein in response to the resolving power or resolution of the upscaled and super resolution-processed first signal being lower than the resolving power or resolution of the second signal, the mixer is configured to output the output image signal in which a proportion of the second signal is higher than a proportion of the first signal.

15. An image display apparatus comprising:
a display;
an image receiver configured to receive an input image signal from an outside of the image display apparatus; and
a signal processing device configured to process the input image signal and output an output image signal, the signal processing device being configured to:
in response to the input image signal being an image signal input through an HDMI input terminal, calculate a spatial frequency of the input image signal and perform a super resolution mode for upscaling and super resolution processing on part of the input image signal of which the spatial frequency is calculated.

16. The image display apparatus of claim 15, wherein in response to the input image signal being the image signal input through the HDMI input terminal connected to a set-top box, the signal processing device is configured to perform the super resolution mode.

17. The image display apparatus of claim 15, wherein in response to the input image signal not being the image signal input through the HDMI input terminal, the signal processing device performs a normal mode for signal processing different than the super resolution mode.

18. An image display apparatus comprising:
a display;
an image receiver configured to receive an input image signal from an outside of the image display apparatus; and
a signal processing device configured to process the input image signal and output an output image signal, the signal processing device being configured to:
in response to a resolution of the input image signal being the same as a resolution of the display, calculate a spatial frequency of the input image signal and perform a super resolution mode for upscaling and super resolution processing on part of the input image signal of which the spatial frequency is calculated.

19. The image display apparatus of claim 18, wherein in response to the resolution of the input image signal being different from the resolution of the display, the signal processing device is configured to perform a normal mode different than the super resolution mode for the upscaling and super resolution processing.

20. A signal processing device for processing an input image signal and outputting an output image signal, the signal processing device comprising:
a frequency divider configured to calculate a spatial frequency of the input image signal and extract a first signal and a second signal from the input image signal based on the calculated spatial frequency;
an upscaler configured to perform upscaling on a signal among the first signal and second signal having a higher spatial frequency than the first signal;
a super resolution processor configured to perform the super resolution processing on the upscaled signal; and
a mixer configured to combine the upscaled and super resolution-processed signal and a remaining signal among the first signal and second signal.

21. The signal processing device of claim 20, further comprising a formatter configured to change a format of the output image signal into a format suitable for displaying the output image signal on a display.

22. The signal processing device of claim 21, wherein after the mixer combines the upscaled and super resolution-processed signal and the remaining signal among the first signal and second signal, the formatter changes the format of the output image signal, which is based on an output from the mixer, into the format suitable for displaying the output image signal on the display, and outputs the output image signal to the display.
